(19) United States
(12) Patent Application Publication
(10) Pub. No.: US 2009/0327436 A1
(43) Pub. Date: Dec. 31, 2009

(54) INSTANT MESSAGING NETWORK CONTROL MODULE

(76) Inventor: Shihn-CHENG CHEN, Yonghe City (TW)

Correspondence Address: Hershkovitz & Associates, LLC, 2845 Duke Street, Alexandria, VA, 22314, US

(21) Appl. No.: 12/165,394

(22) Filed: Jun. 30, 2008

(51) Int. Cl. G06F 15/16

(52) U.S. Cl. 709/206

(57) ABSTRACT

An instant messaging network control module has a processor, a network connecting module, a connecting interface and a memory. The network connecting module is used to connect to an instant messaging server. The connecting interface is used to electronically connect to an outer controlled device. The memory stores a local machine account and a password of the network control module for logging on to the instant message service, a client account and an automatic operating process. The automatic operating process is executed by the processor to allow the network control module to log on to the instant messaging service, receive instant messages sent from a client device logged on to the instant messaging service with the client account and send a corresponding operating command to the outer controlled device. Therefore the network control module provides an easy and cheap way to remotely control the outer controlled device.

### BACKGROUND OF THE INVENTION

1. Field of the Invention

The present invention relates to a control module, and more particularly to a network control module that can connect to an outer controlled device and be in conjunction with an instant messaging server for a logged-in user to use instant messaging services to manipulate the outer controlled device.

2. Description of the Related Art

Many electronic products integrate multiple convenient functions to attract consumers. Electronic products having a remote control capability allow users to remotely manipulate the electronic product via the Internet or radio wave transmission by a remote device like a mobile phone or a computer.

However, using a mobile phone to remotely control the electronic product requires a cell-connection to be maintained and this cell-connection is charged per second or minute according to contract. However. to use a computer, software must be installed and this software may only control one electronic product. Also, each software has a unique user interface that must be learned.

Furthermore, a conventional method for connecting to the remote controlled electronic products from a client computer is to build a network connection. This requires a static or dynamic Internet Protocol (IP) address service. The static IP service is more expensive than the dynamic IP address service. However, the dynamic IP address may be different each time when the electronic product is on-line and it is difficult to search for the electronic product over the Internet. A dynamic Domain Name System (DNS) can solve the dynamic IP address problem. Even so, many computer users are not capable of setting up such a complex system so cannot easily operate the remote controlled electronic product.

In addition, if the client computer is connected to the Internet via a Network Address Translation (NAT) router, the NAT router will block video and audio data sent from the conventional electronic device like network camera.

To overcome the shortcomings, the present invention provides a network control module to mitigate or obviate the aforementioned problems.

### SUMMARY OF THE INVENTION

The main objective of the invention is to provide a network control module that is used to connect to an outer controlled device and can connect to an instant messaging server over the Internet for a logged-in user to use instant messaging services to manipulate the outer controlled device.

The instant messaging network control module in accordance with the present invention comprises a processor, a network connecting module, a connecting interface and a memory. The network connecting module is used to connect to an instant messaging server providing an instant messaging service over the Internet and is electronically connected to the processor. The connecting interface is used to electronically connect to an outer controlled device and is electronically connected to the processor. The memory is electronically connected to the processor and stores a local machine account and a password of the network control module for logging on to the instant message service, a client account of a client device and an automatic operating process. The automatic operating process is executed by the processor to allow the network control module to log on to the instant messaging service, receive an instant message sent from the client device being logged on to the instant messaging service with the client account and send a corresponding operating command to the outer controlled device. Logging on to the instant messaging service over the Internet does not need a static IP address and most Internet users are familiar with the operation of the instant messaging service. Therefore the present invention provides an easy and cheap way to remotely control the outer controlled device.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of an embodiment of an instant messaging network control module in accordance with the present invention;

FIG. 2 is a logic diagram of an automatic operating process executed by a processor in FIG. 1;

FIG. 3 is a logic diagram of an outer message informing process executed by the processor in FIG. 1; and

FIG. 4 is a schematic diagram of the instant messaging network control module and client devices connecting to the instant messaging service server.

### DETAILED DESCRIPTION OF THE PREFERRED EMBODIMENTS

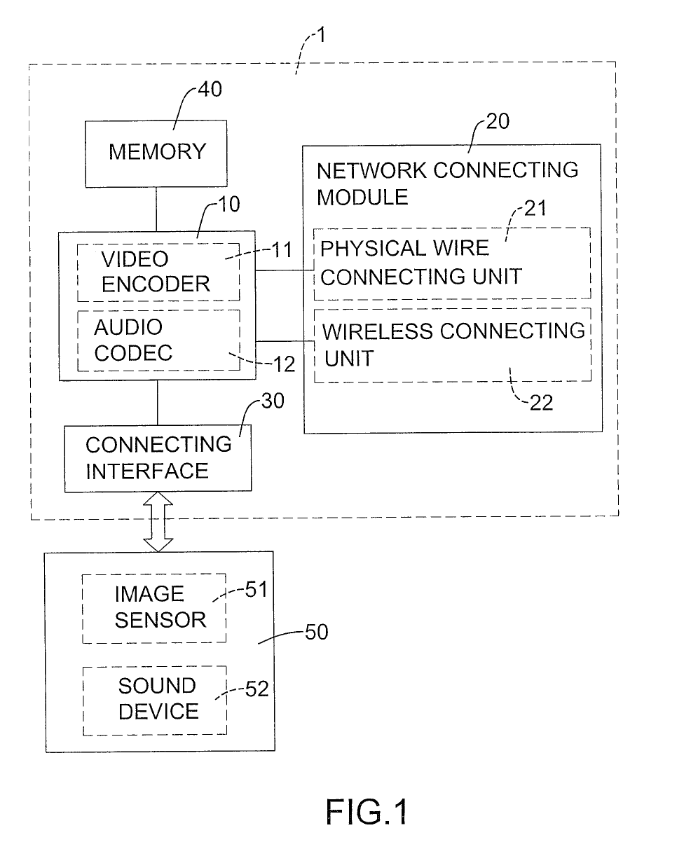

With reference to FIG. 1, an instant messaging network control module (1) in accordance with the present invention comprises a processor (10), a network connecting module (20), a connecting interface (30) and a memory (40). The network control module (1) may be a single electronic device that is used to connect to an outer controlled device (50), or the network control module (1) and the outer controlled device (50) may be integrated into one single electronic device.

The processor (10) may have a video encoder (11) and an audio codec (12). The audio codec (12) is capable of encoding and decoding a digital audio data.

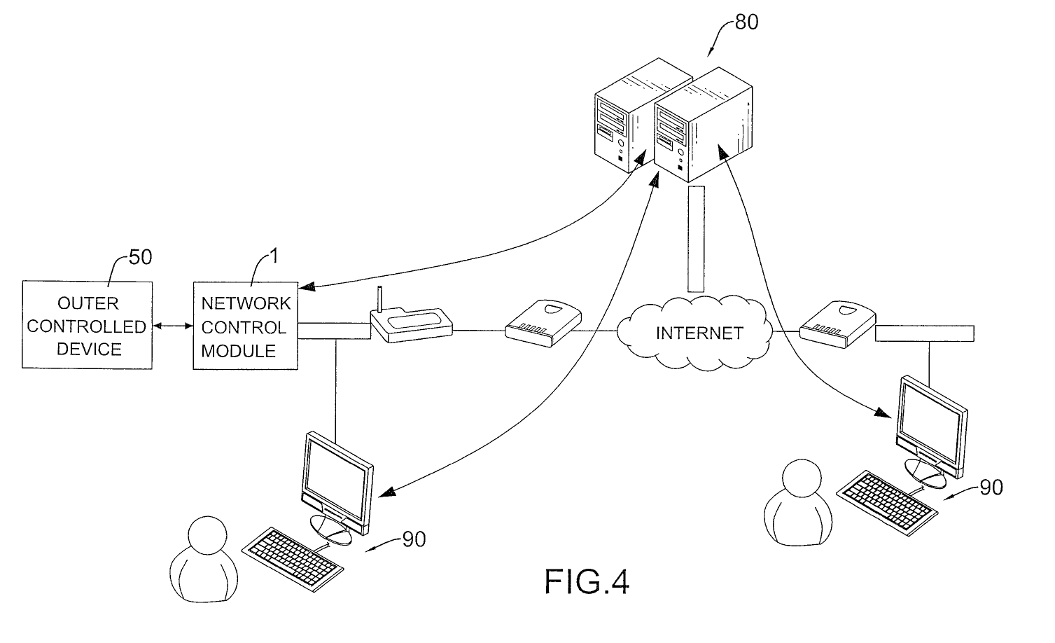

With further reference to FIG. 4, the network connecting module (20) is used to connect to an instant messaging server (80) over the Internet, is electronically connected to the processor (10) and may be a network cable connecting unit (21), a wireless connecting unit (22) or both. The instant messaging server (80) provides an instant message service and may be MSN service (Windows Live Messenger), Yahoo Messenger service, Skype service or the like. The messaging services may be capable of video conferencing. The network cable connecting unit (21) connects to the Internet with a network cable and may be a network interface card. The wireless connecting unit (22) may connect to the Internet under wireless fidelity (Wi-Fi) or WiMAX protocols or 3.5G network.

The connecting interface (30) is electronically connected to the processor (10) and is adapted to electronically connect to the outer controlled device (50) and may be implemented as a Universal Serial Bus (USB) interface, a blue-tooth device, a host control interface or the like. The outer controlled device (50) may be a door intercom device, a home appliance or a robot, and may have an image sensor (51) and a sound device (52). The image sensor (51) is electronically connected to the processor (10) via the connecting interface (30), captures images and converts the captured images into digital video data to allow the video encoder (11) in the processor (10) to encode the digital video data. The sound device (52) is electronically connected to the processor (10) via the connecting interface (30), receives analog audio signals and converts the analog audio signals into digital audio data to allow the audio codec (12) in the processor (10) to encode the digital audio data. The sound device (52) may receive decoded digital audio data sent from the audio codec (12) and convert the decoded digital audio data into analog audio signals.

The memory (40) is electronically connected to the processor (10) and stores a local machine account and a password of the network control module (1), a client account of a client device (90), an automatic operating process and an optional outer message informing process. The local machine account is a registered instant messaging user account for logging on to the instant messaging service provided by the instant messaging server (80) and has a contact list over the instant messaging service. The contact list is a list of accounts a user wants to keep track of to see which account is offline or online and is created by the instant messaging server (80). The client account of the client device (90) is a registered instant messaging user account and would be added as a contact into the contact list of the local machine account of the network control module (1). The client device (90) is capable of using the client account to log on to the instant messaging service over the Internet and sending an instant message having a user command to the processor (10) over the instant messaging service and may be a computer, a cell phone, a personal digital assistant or the like.

The automatic operating process stored in the memory (40) is executed by the processor (10) to log on to the instant messaging service and receive instant messages from the client device (90) and send a corresponding operating command to the outer controlled device (50).

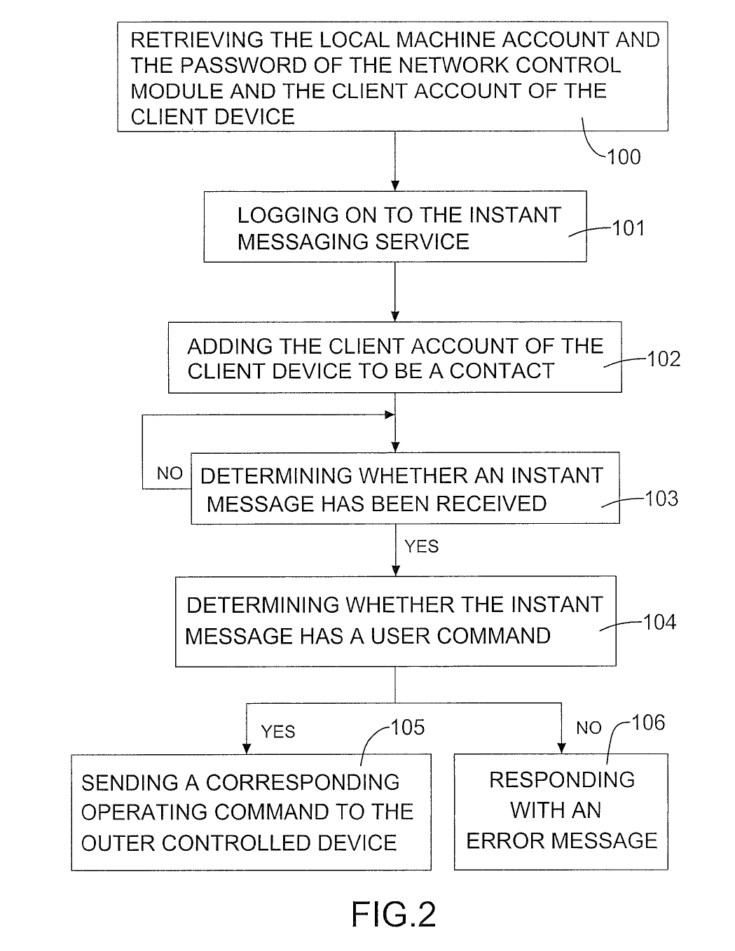

With further reference to FIG. 2, the automatic operating process may comprise steps of retrieving the local machine account and the password of the network control module and the client account of the client device (100), logging on to the instant messaging service (101), adding the client account of the client device to be a contact (102), determining whether an instant message has been received (103), determining whether the instant message has a user command (104), sending a corresponding operating command to the outer controlled device (105) and responding with an error message (106).

The step of retrieving the local machine account and the password of the network control module and the client account of the client device (100) comprises retrieving the local machine account and the password of the network control module (1) and the client account of the client device (90) from the memory (40).

The step of logging on to the instant messaging service (101) comprises using the local machine account and the password of the network control module (1) to log on to the instant messaging service provided by the instant messaging server (80).

The step of adding the client account of the client device to be a contact (102) comprises adding the client account to the contact list of the local machine account since each instant messaging service allows contact list editing. Therefore, when the network control module (1) and the client device (90) are both connected to the instant messaging server (80) and work on-line, the local machine account of the network control module (1) will show as a contact on the client device (90).

The step of determining whether an instant message has been received (103) comprises determining whether the network control module (1) receiving an instant message from the client device (90) over the instant messaging service. If the instant message has been received, the step of determining whether the instant message has a user command (104) is performed. If no instant message has been received the step of determining whether an instant message has been received (103) is repeated.

The step of determining whether the instant message has a user command (104) comprises determining whether the instant message has a valid user command for the processor (10) of the network control module to execute. If the instant message has a valid user command, sending a corresponding operating command to the outer controlled device (105) is performed. If the instant message has an invalid user command, responding with an error message (106) is performed.

The step of sending a corresponding operating command to the outer controlled device (105) comprises producing an operating command according to the user command of the instant message and sending this operating command to the outer controlled device (50).

The step of responding with an error message (106) comprises sending an instant message that represents an input error to the client device (90) over the instant messaging service to inform the user of the client device that an invalid user command was inputted.

The outer message informing process stored in the memory (40) is executed by the processor (10) to receive an outer message sent from the outer controlled device (50) via the connecting interface (30) and send this outer message to the client device (90) over the instant messaging service.

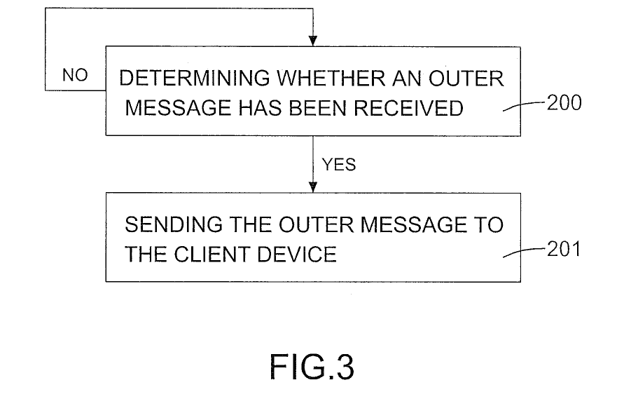

With further reference to FIG. 3, the outer message informing process may comprise steps of determining whether an outer message has been received (200) and sending the outer message to the client device (201).

The step of determining whether an outer message has been received (200) comprises determining whether an outer message has been received from the outer controlled device (50) via the connecting interface (30). When the message is received, the step of sending the outer message to the client device (201) is performed. When no message is received, the step of determining whether an outer message has been received (200) is repeated.

The step of sending the outer message to the client device comprises sending the outer message of the outer controlled device (50) in instant message form to the client device (90) over the instant messaging service.

The user command of the instant message may be a viewing command that requests sending encoded digital video and audio data, and receiving decoded digital audio data. Once the instant message having this viewing command is sent to the network control module (10), the network control module (1) sends an operating command according to the viewing command to the outer controlled device (50) to start the outer controlled device (50). The outer controlled device (50) then sends digital video and audio data to the network control module (10). After encoding the digital video and audio data with the video encoder (11) and the audio codec (12), the network control module (1) sends encoded digital data to the client device (90) over the instant messaging service. The client device (90) then displays received digital data to the user to enable live video communication. Furthermore, the network control module (10) may be capable of sending an outer message sent from the outer controlled device (50) to the client device (90) in an instant message form over the instant messaging service.

Furthermore, the network control module (10) may receive encoded digital audio data from client device (90) over the instant messaging service. After decoding the digital audio data with the audio codec (12), the network control module (1) sends the decoded digital audio data to the outer controlled device (50). The sound device (52) receives the decoded digital audio data sent from the audio codec (12) and converts the decoded digital audio data into analog audio signals.

When applying the network control module (1) to outer controlled device (50) like a home appliance, such as an air-conditioner, the user of the client device (90) can remotely change a status of the air-conditioner through the network control module (1) over the instant messaging service. When the outer controlled device (50) is a robot, the user may send some instant messages having user command that request specific actions, the robot then perform the actions. The user may also receive instant messages from the outer controlled device (50).

Such a network control module does not need a static IP address and is capable of automatically logging on to the instant messaging service when connecting to the Internet. Therefore, the user can control the network control module easily by using the instant messaging service and save money on renting the static IP address service from an Internet services provider. Additionally, multiple network control modules can be set up to communicate with the same client device (90) that has multiple contacts in the same contact list, so the user can interact with those network control modules by logging on to just one instant messaging service, which is more convenient that browsing for multiple static or dynamic IP addresses. Furthermore, most Internet users are familiar with instant messaging services and do not need to learn other remote desktop control software, so the present invention facilitates ease of use and allows more people to benefit from application of the outer controlled device. Besides, the encoded digital video and audio data sent from the network control module are not be blocked by a Network Address Translation (NAT) router because the instant messaging services are capable of allowing the network control module to send the video and audio data through the NAT router.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An instant messaging network control module comprising
a processor;
a network connecting module electronically connected to the processor and used to connect to an instant messaging server providing an instant messaging service over the Internet;
a connecting interface being connected to the processor and being adapted to electronically connect to an outer controlled device; and
a memory being electronically connected to the processor and storing
a local machine account and a password of the network control module for logging on to the instant message service;
a client account of a client device; and
an automatic operating process being executed by the processor to allow the network control module to log on to the instant messaging service, receive an instant message sent from the client device being logged on to the instant messaging service with the client account and send a corresponding operating command to the outer controlled device.

2. The instant messaging network control module as claimed in claim 1, wherein the automatic operating process comprises steps of:
retrieving the local machine account and the password of the network control module and the client account of the client device from the memory;
logging on to the instant messaging service with the local machine account and the password of the network control module;
adding the client account of the client device to be a contact in an instant messaging service contact list created by the instant messaging server;
determining whether an instant message from the client device over the instant messaging service has been received;
determining whether the instant message has a user command when an instant message has been received;
sending a corresponding operating command to the outer controlled device; and
responding with an error message to the client device over the instant messaging service when the user command is invalid.

3. The instant messaging network control module as claimed in claim 1, wherein the memory further stores an outer message informing process being executed by the processor to receive an outer message being sent from the outer controlled device via the connecting interface and sending this outer message to the client device over the instant messaging service.

4. The instant messaging network control module as claimed in claim 1, wherein the network connecting module is a network cable connecting unit.

5. The instant messaging network control module as claimed in claim 1, wherein the network connecting module is a wireless connecting unit.

6. The instant messaging network control module as claimed in claim 1, wherein the network connecting module comprises a network cable connecting unit and a wireless connecting unit.

7. The instant messaging network control module as claimed in claim 1, wherein the outer controlled device is a home appliance.

8. The instant messaging network control module as claimed in claim 1, wherein the outer controlled device is a robot.

9. The instant messaging network control module as claimed in claim 1, wherein the connecting interface is a Universal Serial Bus (USB) interface or a blue-tooth device or a host control interface.

10. The instant messaging network control module as claimed in claim 1, wherein the local machine account is a registered instant messaging user account for logging on to the instant messaging service provided by the instant messaging server and has a contact list over the instant messaging service;
the contact list is a list of accounts a user wants to keep track of to see which account is offline or online and is created by the instant messaging server; and
the client account of the client device is a registered instant messaging user account and is added as a contact into the contact list of the local machine account of the network control module.

11. The instant messaging network control module as claimed in claim 2, wherein:
the processor further has a video encoder; and
the outer controlled device further has an image sensor being electronically connected to the processor via the connecting interface, capturing images and converting the captured images into digital video data to allow the video encoder to encode the digital video data.

12. The instant messaging network control module as claimed in claim 3, wherein the outer message informing process comprises steps of:
determining whether an outer message has been received from the outer controlled device via the connecting interface; and
sending the outer message to the client device in an instant message form over the instant messaging service.

13. The instant messaging network control module as claimed in claim 4, wherein the network cable connecting unit is a network interface card.

14. The instant messaging network control module as claimed in claim 5, wherein the wireless connecting unit connects to the Internet under wireless fidelity (Wi-Fi) or WiMAX protocols or 3.5G network.

15. The instant messaging network control module as claimed in claim 11, wherein:
the processor further has an audio codes being capable of encoding and decoding a digital audio data; and
the outer controlled device further has a sound device being electronically connected to the processor via the connecting interface, receiving analog audio signals and converting the analog audio signals into digital audio data to allow the audio codec in the processor to encode the digital audio data, receiving decoded digital audio data sent from the audio codec in the processor and converting the decoded digital audio data into analog audio signals.

16. The instant messaging network control module as claimed in claim 15, wherein:
the user command sent to the network control module is a viewing command; and
the network control module sends an operating command according to the viewing command to the outer controlled device to start the outer controlled device to request sending encoded digital video and audio data, and receiving decoded audio data.
